(19) United States
(12) Patent Application Publication
(10) Pub. No.: US 2025/0102244 A1
(43) Pub. Date: Mar. 27, 2025

(54) Composite Fin Structure, Radiator, and Fuel Cell Cooling System

(71) Applicant: Caterpillar Inc., Peoria, IL (US)

(72) Inventors: Lei YU, Wuxi (CN); Gengxin LIU, Wuxi (CN); Guoping TIAN, Wuxi (CN); Yumei WANG, Wuxi (CN); Yuerou WANG, Wuxi (CN)

(73) Assignee: Caterpillar Inc., Peoria, IL (US)

(21) Appl. No.: 18/889,662

(22) Filed: Sep. 19, 2024

(30) Foreign Application Priority Data
Sep. 21, 2023 (CN) 202311226552.X

(51) Int. Cl. F28F 3/08; F28D 21/00

(52) U.S. Cl. CPC F28F 3/08; F28D 2021/0043; F28F 2215/04

(57) ABSTRACT

The present disclosure relates to a composite fin structure for a radiator, comprising a plurality of elongated corrugated fins arranged in parallel and spaced apart from each other. Air flow channels are defined between the opposing main side surfaces of adjacent fins, allowing cooling air to flow therethrough along a longitudinal direction of the fins. It is characterized in that each fin comprises a first corrugated fin section having a first waveform and a second corrugated fin section having a second waveform, with extending directions of the first and second waveforms being consistent with the longitudinal direction of the fin. A fin density of the first waveform is greater than that of the second waveform, and the first corrugated fin section extend at least in an inlet side region of each air flow channel. This invention also relates to a radiator with the composite fin structure, as well as a fuel cell cooling system comprising the radiator.

### TECHNICAL FIELD

The present disclosure relates to a technical field of a fuel cell cooling system, in particular a composite fin structure for a radiator, a radiator with such a composite fin structure, and a fuel cell cooling system comprising the radiator.

### BACKGROUND

In a fuel cell cooling system, cooling liquid flows via cooling liquid passages between anode and cathode plates of a fuel cell stack. With forced convection heat-exchanging of the cooling liquid, heat produced during a working process of fuel cells is removed. The cooling liquid may be deionized water or a mixture of water and ethylene glycol. The cooling liquid thus heated dissipates heat in a radiator, which reduces temperature of the cooling liquid. The cooling liquid thus cooled is then delivered to the fuel cell stack for continuously cooling the fuel cell stack.

With respect to the design of the radiator of the fuel cell cooling system, it faces greater challenges than a conventional cooling water system for a diesel system, which are reflected mainly in the following two points: 1) the required heat-exchanging amount has increased. Heat-exchanging amount by the water tank of traditional diesel systems accounts for approximately 33% of the engine's power, while the required heat-exchanging amount by the radiator of the fuel cell cooling system is up to two to three times higher than the amount obtained by the water tank; 2) The temperature difference for heat-exchanging with ambient air has decreased. The temperature difference for heat-exchanging between the water temperature in the water tank of a traditional fuel-powered vehicle and the ambient air temperature is around 55° C. However, due to the relatively low operating temperature of the fuel cells, the temperature difference for heat-exchanging between the cooling water temperature in the radiator of the fuel cell system and the ambient air temperature is smaller, around 28° C. With the traditional radiator layout and the fin form, larger heat-exchanging space is required for the heat-exchanging with the fuel cells, which means that the size of the radiator of a fuel cell vehicle is increased and the fuel cell vehicle has to be in a larger volume, and cost for the cooling system is made higher. And a larger radiator would pose greater difficulties for the interior space design of the fuel cell vehicle.

Accordingly, it is the object of the present disclosure to solve one or more of the above problems.

### SUMMARY OF THE DISCLOSURE

To solve the cooling problem of fuel cells, the present disclosure provides an improved composite fin structure for the radiator of the fuel cell cooling system, which can increase heat-exchanging capacity of the radiator to meet the heat-exchanging requirement and reduce the size of the radiator and the fuel cell cooling system (the size of the water tank and the fan), thereby lowering the system cost.

According to one aspect of the present disclosure, a composite fin structure for the radiator is provided, comprising a plurality of elongated corrugated fins spaced from each other and arranged in parallel. Opposing main side surfaces of adjacent fins define air flow channels for cooling air to flow therethrough along a longitudinal direction of the fins. It is characterized in that each fin comprises a first corrugated fin section having a first waveform and a second corrugated fin section having a second waveform, wherein extending directions of the first waveform and the second waveform are consistent with the longitudinal direction of the fin; a fin density of the first waveform is larger than that of the second waveform; and the first corrugated fin section extends at least in an inlet side region of each air flow channel.

Preferably, a wave pitch of the first waveform is smaller than that of the second waveform, and/or a wave amplitude of the first waveform is greater than that of the second waveform.

Preferably, the first corrugated fin section is provided in an outlet side region of the air flow channel.

Preferably, the fin consists of a first corrugated fin section and a second corrugated fin section, wherein along a direction of air flow in the air flow channel, the first corrugated fin section is provided upstream of the second corrugated fin section.

Preferably, a length of the first corrugated fin section is designed to account for ⅓ to ½ of an entire longitudinal length of the fin comprising the first corrugated fin section.

Preferably, the composite fin structure is formed as a one-piece part, comprising said fins and connection base portions located at edge sides of the fins.

Preferably, the one-piece part extends in a pulse waveform along an arranging direction of the fins, wherein adjacent edge sides of the fins are connected via the connecting base portions at peaks and troughs of the pulse waveform.

By means of the composite fin structure of the present disclosure, heat-exchanging capacity is maximized by taking the advantage of the fact that the heat-exchanging temperature difference is generally larger in the inlet side region of the air flow channel, and heat-exchanging surface area and heat-exchanging capacity are increased significantly with an acceptable increase in air flow resistance; therefore, heat dissipation area and heat dissipation coefficient are increased with an extremely high cost-performance ratio, so that the size of the cooling system (radiator and fan) is reduced and the cost is lowered, thereby addressing the issues of the bulky and costly cooling system currently found in the fuel cell vehicles.

According to another aspect of the present disclosure, a radiator for a fuel cell cooling system is provided, comprising a radiator core. The radiator core comprises a plurality of substantially flat fluid plates spaced apart and arranged in parallel along a thickness direction of the radiator core, with a plurality of fluid channels being defined in each fluid plate for fluid to be cooled to flow therethrough; and fin group(s) arranged between adjacent fluid plates, wherein the fin group(s) has the above composite fin structure.

Preferably, the fluid channels extend in a lengthwise direction of the radiator core, and the air flow channels are arranged side by side in the lengthwise direction of the radiator core.

According to another aspect of the present disclosure, a fuel cell cooling system is provided, which comprises a fuel cell and a radiator for cooling the fuel cell; the fuel cell and the radiator are fluidly connected to form a cooling circuit wherein cooling liquid circulates, characterized in that, the radiator is the above-said radiator, and the cooling liquid flows, as fluid to be cooled, into fluid channels defined in fluid plates of the radiator core.

In the fuel cell cooling system according to the present disclosure, the heat-exchanging surface area is increased with the air flow resistance being increased to an acceptable extent, which effectively improves the heat dissipation capacity of the radiator, thereby reducing the size of the radiator and the entire fuel cell cooling system and lowering the system cost.

### BRIEF DESCRIPTION OF THE DRAWINGS

The drawings described herein are provided for further understanding features and advantages of an example of the present disclosure:

FIG. 1 is a perspective view of a radiator according to the present disclosure;

FIG. 2 is a perspective view of a heat dissipation unit of a radiator core of a radiator according to the present disclosure;

FIG. 3 shows a perspective view of a portion of the heat dissipation unit shown in FIG. 2 after removing a fluid plate on one side;

FIG. 4 shows a schematic diagram of some segments of a composite fin structure according to the present disclosure; and

FIG. 5 is a schematic diagram of a fuel cell cooling system according to the present disclosure.

### DETAILED DESCRIPTION

Hereinafter, the embodiments of the present disclosure will be described in detail with reference to the drawings. Same reference numerals are used in all drawings to refer to the same or similar parts.

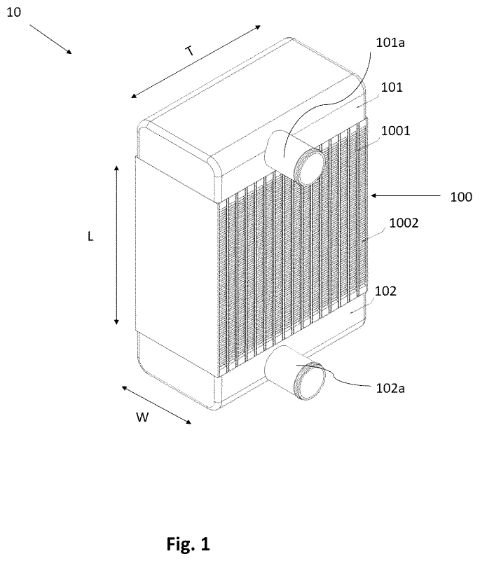

As shown in FIG. 1, a radiator 10 for the fuel cell cooling system according to the present disclosure comprises a radiator core 100 and a flow-division chamber 101 and a flow-collecting chamber 102 located on both ends of the radiator core. An inlet pipe 101a is fluidly connected to the flow-division chamber 101 such that the fluid to be cooled can enter the flow-division chamber. The fluid discharged from the radiator core enters the flow-collecting chamber 102 and flows out through the outlet pipe 102a. The radiator core 100 comprises a plurality of generally flat fluid plates (with channels provided therein) 1001 spaced apart and arranged in parallel along a thickness direction T of the radiator core, and fin groups 1002 arranged between adjacent fluid plates. Adjacent fluid plates and the fin group arranged therebetween constitute a basic heat dissipation unit.

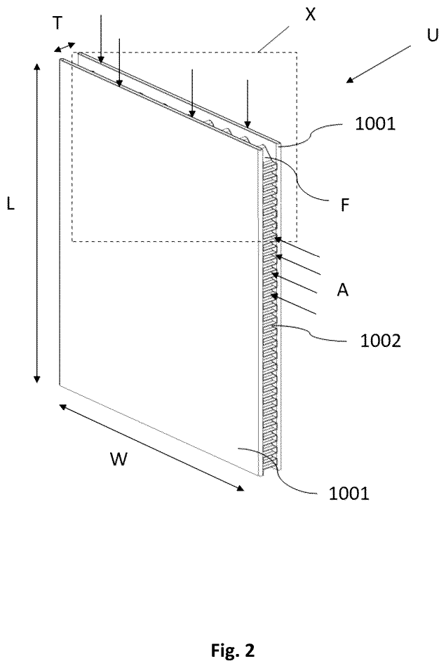

A heat dissipation unit U of the radiator core 100 of the radiator in the present disclosure is shown in FIG. 2. In the illustrated embodiment of the heat dissipation unit, in each fluid plate 1001, a plurality of fluid channels are defined, extending along a lengthwise direction L of the radiator core. In the example shown, the fluid to be cooled (the cooling liquid in the fuel cell cooling system) enters the fluid channels through inlets located on the upper side and exits through outlets located on the lower side. The fin group 1002 comprises a plurality of elongated corrugated fins F extending along a widthwise direction W of the radiator core. The fins are arranged in parallel and spaced apart from each other in a lengthwise direction of the heat dissipation unit, thus defining air flow channels between opposing main sides of adjacent fins F for cooling air A to pass therethrough. The air flow channels extend generally along a widthwise direction of the heat dissipation unit (i.e., parallel to a longitudinal direction of the fins) and are arranged side by side in the lengthwise direction of the heat dissipation unit. The cooling air A enters the air flow channels through inlets located on one end side, in the widthwise direction, of the heat dissipation unit, exchanges heat with the fluid to be cooled in the fluid channels of the fluid plates when flowing through the air flow channels, thereby reducing the temperature of the fluid to be cooled, and the air heated exits through outlets located on the other end side in the widthwise direction of the heat dissipation unit.

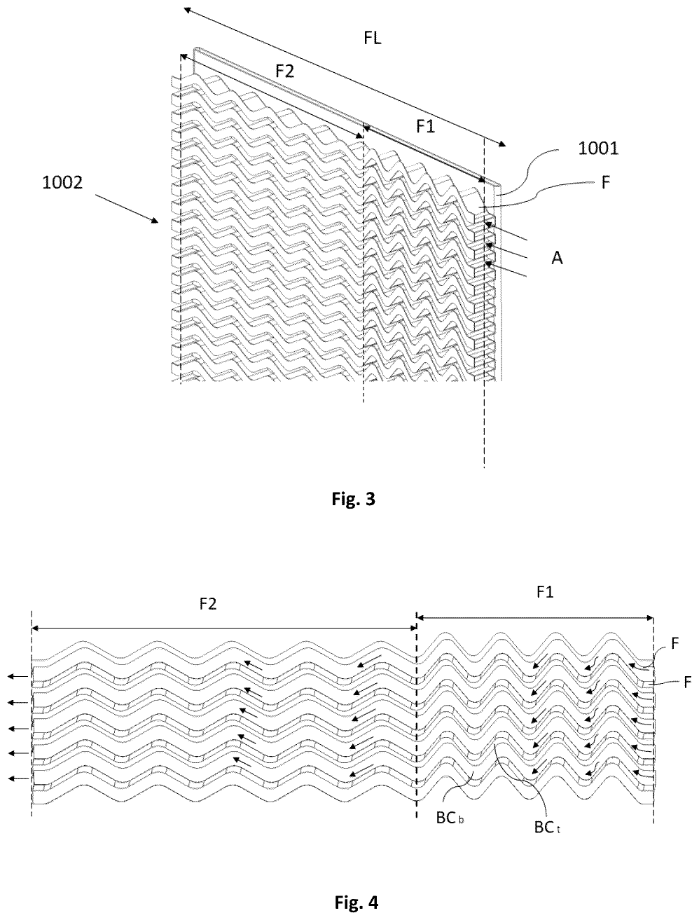

FIGS. 3 and 4 are enlarged schematic views of a partial area X of the heat dissipation unit. According to the exemplary embodiment shown in FIGS. 3 and 4, the fin group 1002 in each heat dissipation unit has a composite fin structure where each corrugated fin F comprises a first corrugated fin section F1 extending in a first waveform along a longitudinal direction FL of the fin and a second corrugated fin section F2 extending in a second waveform along the longitudinal direction FL of the fin. The fin density of the first waveform is greater than the fin density of the second waveform. The first corrugated fin section is arranged in the inlet side region of the air flow channel.

In this context, “fin density” refers to the heat-exchanging surface area per unit length measured along the longitudinal direction of the fin. The calculation of the fin density can be done by dividing the total heat-exchanging surface area of the corrugated fin within a specific longitudinal length segment by the length of that segment.

The variation in fin density can be achieved by changing the waveform characteristic parameters (including but not limited to wave pitch and/or amplitude). In the embodiment of the present disclosure, the fin density of the first waveform is made greater than the fin density of the second waveform by arranging the wave pitch of the first waveform to be smaller than the wave pitch of the second waveform. Optionally or additionally, the amplitude of the first waveform can be arranged to be greater than the amplitude of the second waveform to achieve greater fin density for the first waveform relative to the second waveform.

In the embodiment shown in FIG. 3, each fin F consists of a first corrugated fin section F1 and a second corrugated fin section F2. Along the flow direction of the air A (i.e., along the longitudinal direction FL of the fin), the first corrugated fin section is positioned upstream of the second corrugated fin section. Advantageously, the length of the first corrugated fin section is designed to account for ⅓ to ½ of the entire longitudinal length of the fin comprising the first corrugated fin section, so that the heat-exchanging amount achieved by the first corrugated fin section accounts for at least 80% of the total heat-exchanging amount achieved by the entire fin.

The composite fin structure according to the present disclosure utilizes hybrid corrugated fins, which incorporate two kinds of waveforms with different wave amplitudes and wave pitches. Specifically, fins with a higher density are provided on the air inlet side of the air flow channels to increase the heat-exchanging surface area, and the increase in heat-exchanging amount is particularly pronounced when there is significant temperature difference between the cooling air and the fluid to be cooled in the inlet side region of the air flow channel. In an exemplary embodiment, the arrangement of the first corrugated fin section allows for a 20% increase in heat-exchanging area (compared with a fin of the same length having only the second waveform over its entire longitudinal length), while the air flow resistance is increased only by 1%, which is very little or negligible compared with the increase in heat-exchanging amount. Therefore, the heat transfer capacity in the inlet side region of the air flow channel can be maximized as much as possible.

Although FIG. 3 shows that the first corrugated fin section is only arranged in the inlet side region of the air flow channel, it can be understood that a first corrugated fin section may also be arranged in the outlet side region of the air flow channel. That is, the inlet side region and the outlet side region of the air flow channel can be provided with the first corrugated fin sections respectively, while the second corrugated fin section is arranged in the central region of the air flow channel. Based on this configuration, a large portion of the preset heat-exchanging amount is achieved by the first corrugated fin section in the inlet side region of the air flow channel, thus significantly reducing the longitudinal dimension of the fin and therefore the corresponding flow resistance due to the reduced size. Furthermore, arranging a small-sized first corrugated fin section in the outlet side region can increase the heat-exchanging amount without causing a significant increase in flow resistance.

By additionally arranging a first corrugated fin section in the outlet side region of the air flow channel, the fin density and the heat-exchanging surface area of the fins in the outlet side region of the air flow channel are increased, thereby alleviating the problem of reduced heat-exchanging amount which usually appears in the outlet side region of the air flow channel due to small heat-exchanging temperature differences. Thus, by arranging fins having as larger heat-exchanging surface area as possible over a specific width of the heat dissipation unit, the radiator can be designed to have a width as smaller as possible for specific cooling requirements.

Although the embodiment shown in FIG. 1 depicts the extending direction of the fluid channels in the fluid plates is consistent with the lengthwise direction of the radiator core, it can be understood that other configurations of fluid channels are also feasible. For example, the fluid channels can be configured in a “U” shape or a “W” shape. Regardless of the configuration of the fluid channels, it is beneficial for increasing the heat-exchanging surface area and the heat-exchanging capacity of the fins to arrange the first corrugated fin section with a high fin density in the inlet side region of the air flow channel. This is because in addition to relatively high air speed in the inlet side region of the air flow channel, the profile of the air flow channel defined by dense waveforms also facilitates the formation of turbulence, and the heat-exchanging coefficient in corresponding section of the air flow channel is improved and by increased heat-exchanging surface area of the fins, the heat-exchanging capacity may be maximized. Although the air resistance increases along the corresponding section with dense waveforms in the air flow channel, it can be ignored in view of the improvement in heat-exchanging capacity.

In the embodiments shown in FIGS. 2-4, the fin group 1002 is formed as a one-piece part. The fins F are held in shape and placed between the fluid plates by connecting base portions BCt and BCb located on edge sides of the fins. In the exemplary embodiments shown, an integral fin group extends in a pulse waveform along the lengthwise direction of the radiator core, with adjacent edges of the fins being connected via the connecting base portions BCt at the peaks of the pulse waveform and connecting base portions BCb at the troughs of the pulse waveform. These connecting base portions are fixedly connected with the adjacent fluid plates by welding. The connecting base portions are preferably flat to provide a large welding area between the fin group and the fluid plates. Therefore, it is easy to manufacture a fin group with the composite fin structure according to the present disclosure by sheet metal stamping, and it is easy to attach such a fin group onto the fluid plates by brazing.

Although FIG. 1 depicts the radiator as a plate fin heat exchanger, it can be designed as a tube-and-fin heat exchanger.

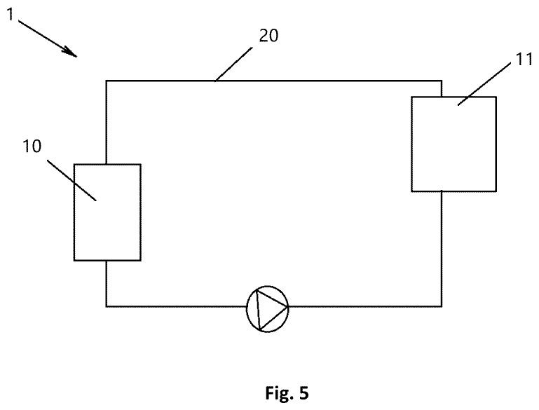

According to the present disclosure, a highly efficient fuel cell cooling system 1 can be obtained by using a radiator that significantly improves heat-exchanging efficiency within a certain volume. Referring to FIG. 5, the fuel cell cooling system 1 includes a fuel cell 11 and the aforementioned radiator 10 for cooling the fuel cell. As shown in FIG. 5, the fuel cell cooling system 1 includes a cooling circuit 20 wherein cooling liquid circulates, with the fuel cell 11 and the radiator 10 being arranged in this cooling circuit. The cooling liquid in the cooling circuit, after carrying away heat from the fuel cell, flows into the fluid channels defined within the fluid plates of the radiator core, exchanges heat with the air, cools down, and finally flows out of the radiator. Under the action of a pump, the cooling liquid re-enters the fuel cell. This cycle repeats continuously.

### INDUSTRIAL APPLICABILITY

For a better understanding of the present disclosure, the assembly method and operation principle of the radiator of the present disclosure are described as follows:

Referring to FIG. 1, a plurality of fluid plates 1001 are provided, which are arranged in an upright state and spaced along the thickness direction of the radiator core. Between each two adjacent fluid plates, the fin groups 1002 are arranged as follows: elongate corrugated fins of the same configuration are arranged at certain intervals in the vertical direction (the lengthwise direction of the radiator core), such that the longitudinal direction FL of the fins F is substantially consistent with the widthwise direction of the radiator core and the first corrugated fin section F1 of the fins is located on the windward side of the radiator core. With all fin groups 1002 being pre-assembled between adjacent fluid plates or between fluid plates and side plates, and with the connecting base portions of the fin groups being attached to the side surfaces of the fluid plates, all parts in the whole assembly are fixed in place by brazing or other methods, thus forming the radiator core 100. The flow-division chamber 101 is installed at the upper end of the radiator core, and the flow-collecting chamber 102 is installed at the lower end of the radiator core, allowing the cooling liquid to flow into and out of the radiator core in a predetermined manner.

Thus, the well-assembled radiator 10 operates in a predetermined manner: the cooling liquid flows into the fluid channels of the fluid plates of the radiator core, exchanges heat with the air flowing into each air flow channel, then the cooled cooling liquid is discharged from the radiator, while the air heated is expelled to the external environment. The cooled cooling liquid exiting the radiator then enters the fuel cell for cooling the fuel cell, and the cooling liquid carrying the heat generated by the fuel cell reaction and leaving the fuel cell then enters the radiator for being cooled.

The radiator according to the present disclosure increases heat-exchanging area and improves heat-exchanging efficiency without changing the size of the radiator, thereby significantly reducing the manufacturing cost of the fuel cell cooling system. Furthermore, the heat dissipation unit used has a flat shape, and the length of extension of the air flow channels provides room for improvement for the arrangement and use of the first corrugated fin section with high fin density. By properly designing the ratio of the extension length of the first corrugated fin section to the total extension length of the fin, the composite fin structure according to the present disclosure can also avoid the problem of significantly reduced heat-exchanging efficiency between cooling liquid in flow paths and air due to increased flow resistance of air and air trapping in the downstream section of the air flow channel. This is because the heat-exchanging amount obtained via the first corrugated fin section accounts for approximately 80% of the total design heat-exchanging amount of the whole fin, and the fin sections downstream the first corrugated fin section have lower fin density for reducing airflow resistance, thereby still achieving the required heat-exchanging between cooling liquid and air in downstream portions of the air flow channel and ensuring the eventual discharging of air. By application of the aforementioned hybrid fins, the radiator of the present disclosure exhibits significantly better heat-exchanging performance than existing radiators without increasing the overall volume.

The above description only illustrates exemplary embodiments of the radiator and the fuel cell cooling system according to the present disclosure. The structure/configuration of the radiator is not limited to the specific embodiments described here; on the contrary, each part can be used independently and separately from the other parts described here. When referring to “one example”, “another example”, “an example” etc. throughout the entire specification, it means that an element (such as a feature, structure, and/or characteristic) related to the example is included in at least one example described here, and may or may not appear in other examples. Additionally, it can be understood that a plurality of elements described in any example can be combined in any appropriate manner in a plurality of different examples, unless explicitly stated otherwise in the context.

This specification uses examples to disclose the invention, including the best embodiments, and enables any person skilled in the art to implement the invention. The scope of patent protection for the invention is defined by the claims and may include other examples that a person skilled in the art would think of. If these other examples have structural elements that do not differ from the literal language of the claims, or if these other examples include equivalent structural elements which do not constitute a substantive difference from the literal language of the claims, these other examples should fall within the scope of the claims.

1. A composite fin structure for a radiator, comprising a plurality of elongated corrugated fins arranged in parallel and spaced apart from each other, with air flow channels being defined between opposing main side surfaces of adjacent fins for cooling air to flow therethrough along a longitudinal direction of the fins, characterized in that, each of the fins comprises a first corrugated fin section having a first waveform and a second corrugated fin section having a second waveform, wherein extending directions of the first waveform and the second waveform are consistent with the longitudinal direction of the fin, and a fin density of the first waveform is greater than that of the second waveform, and the first corrugated fin section extends at least in an inlet side region of each air flow channel.

2. The composite fin structure according to claim 1, characterized in that, a wave pitch of the first waveform is smaller than that of the second waveform, and/or a wave amplitude of the first waveform is greater than that of the second waveform.

3. The composite fin structure according to claim 2, characterized in that, the first corrugated fin section is provided in an outlet side region of the air flow channel.

4. The composite fin structure according to claim 1, characterized in that, the fin consists of a first corrugated fin section and a second corrugated fin section, wherein along a direction of air flow in the air flow channel, the first corrugated fin section is provided upstream of the second corrugated fin section.

5. The composite fin structure according to claim 4, characterized in that, a length of the first corrugated fin section is designed to account for ⅓ to ½ of an entire longitudinal length of the fin comprising the first corrugated fin section.

6. The composite fin structure according to claim 1, characterized in that, the composite fin structure is formed as a one-piece part, comprising the fins and connecting base portions located at edge sides of the fins.

7. The composite fin structure according to claim 6, characterized in that, the one-piece part extends in a pulse waveform along an arranging direction of the fins, wherein adjacent edge sides of the fins are connected via the connecting base portions at peaks and troughs of the pulse waveform.

8. A radiator for a fuel cell cooling system, comprising a radiator core which comprises a plurality of substantially flat fluid plates spaced apart and arranged in parallel along a thickness direction of the radiator core, with a plurality of fluid channels being defined in each fluid plate for fluid to be cooled to flow therethrough; and fin group(s) arranged between adjacent fluid plates, wherein the fin group(s) has a composite fin structure according to claim 1.

9. The radiator according to claim 8, characterized in that the fluid channels extend in a lengthwise direction of the radiator core, and the air flow channels are arranged side by side in the lengthwise direction of the radiator core.

10. A fuel cell cooling system, comprising a fuel cell and a radiator configured to cool the fuel cell, wherein the fuel cell and the radiator are fluidly connected to form a cooling circuit wherein cooling liquid circulates, characterized in that, the radiator is a radiator according to claim 8, and the cooling liquid flows, as fluid to be cooled, into fluid channels defined in fluid plates of the radiator core.
